(19) United States
(12) Patent Application Publication
(10) Pub. No.: US 2026/0306344 A1
(43) Pub. Date: Oct. 8, 2026

(54) MODULAR WALL-MOUNTED WELLNESS SYSTEM WITH ADJUSTABLE TRACK SYSTEM

(71) Applicant: Wellness Wall System LLC, Des Moines, IA (US)

(72) Inventor: Amy J. Heinz, Des Moines, IA (US)

(21) Appl. No.: 19/633,126

(22) Filed: Mar. 30, 2026

Related U.S. Application Data
(60) Provisional application No. 63/782,387, filed on Apr. 2, 2025.

(51) Int. Cl. A61H 15/00

(52) U.S. Cl. CPC A61H 15/00; A61H 2015/005; A61H 2015/0064; A61H 2201/0107; A61H 2201/0126; A61H 2201/0192; A61H 2201/1692; A61H 2201/1695

(57) ABSTRACT

A wall-mounted wellness system comprising: one or more module interface panels, a track system secured to each of the one or more module interface panels, and a plurality of interchangeable therapeutic modules. Each module interface panel of the one or more module interface panels is securable to a wall. The track system includes a plurality of T-tracks and each T-Track of the plurality of T-Tracks includes a T-Slot. The plurality of interchangeable therapeutic modules are positionable along the T-slots of the plurality of T-tracks. Each interchangeable therapeutic module of the plurality of interchangeable therapeutic modules is configured to be slidably adjustable along a length of at least one T-Track of the plurality of T-Tracks such that each interchangeable therapeutic module of the plurality of interchangeable therapeutic modules provides continuous positional adjustment.

### CROSS REFERENCE TO RELATED APPLICATIONS

This application claims the priority benefit of U.S. Provisional Patent Application No. 63/782,387, filed Apr. 2, 2025, which is hereby incorporated by reference in its entirety.

### TECHNICAL FIELD

The present disclosure generally relates to systems and methods for a modular wellness system and the use thereof.

### BACKGROUND

There are many companies engaged in the field of wall-mounted track systems. Often the systems and methods of these companies face limitations including: lack of adjustability; therapeutic components limited to specific uses; limited positioning opportunities; and inability to combine into a single framework.

While several wall-mounted track systems have been made and used, it is believed that no one prior to the inventors has made or used the invention described in the appended claims.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 depicts one version of a wellness system of the present disclosure;

FIG. 2 depicts the wellness system of FIG. 1 with labeled elements of a track system and labeled examples of therapeutic modules;

FIG. 3 depicts another version of a wellness system of the present disclosure;

FIG. 4 depicts the wellness system of FIG. 3 with labeled examples of therapeutic modules;

FIG. 5 shows a partially exploded version of a module interface panel of the wellness system of FIG. 3;

FIG. 6 depicts peanut ball therapeutic module of the wellness system of FIG. 3; and

FIG. 7 illustrates an exemplary method for customizing wellness systems of the present disclosure.

### DETAILED DESCRIPTION

The following description of certain examples of the technology should not be used to limit its scope. Other examples, features, aspects, versions, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, versions, examples, etc. described herein may be combined with any one or more of the other teachings, expressions, versions, examples, etc. that are described herein. The following-described teachings, expressions, versions, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims..

In one or more versions, wellness systems of the present disclosure may include comprehensive musculoskeletal relief systems which may be engineered for restaurant staff, office workers, service providers, construction workers, hospital employees and the like, as well as in-home as a regular daily therapy devise, or other uses. In one or more versions, wellness systems of the present disclosure may include an innovative, mounted system for promoting wellbeing in varying settings. In one or more versions, wellness systems of the present disclosure may act as an interactive wellness hub which may feature adjustable and removable components for trigger point therapy, stretching, massage, and/or other wellness benefits. In one or more versions, wellness systems of the present disclosure may be customizable to fit the desires of varying users.

In one or more versions, wellness systems of the present disclosure may be expandable with expansion modules. In such versions, expansion modules may be able to be integrated into the wellness systems of the present disclosure such that the expansion modules add new features to the wellness systems of the present disclosure. In one or more versions, wellness systems of the present disclosure may include a band expansion module which may include workout bands configured to allow a user to perform resistance exercises and/or stretching in addition to the original features of wellness systems of the present disclosure. In one or more versions, wellness systems of the present disclosure may allow users to break up sedentary behaviors with movement prompts and activity challenges. In one or more versions, wellness systems of the present disclosure may centralize all physical wellness resources in one visible, engaging location; create social connection through shared wellness goals and activities; make wellness visible and interactive; and/or make other benefits more accessible.

In one or more versions, benefits of wellness systems of the present disclosure may include: targeted relief for multiple body regions including forearm, hand, deltoid, hip, glute, and lower back pain -- areas overlooked by spine-focused devices; a wall-mounted, space-efficient design that may integrate into workplaces, homes, or other locations, and may ensure consistent accessibility while saving valuable floor space; and functioning as a preventative, daily maintenance system while providing an accessible workplace wellness solution. In one or more versions, wellness systems of the present disclosure may include adjustable rollers on tracks and customizable trigger point balls which may offer precise muscle tension release. In one or more versions, wellness systems of the present disclosure may provide expandability through attachments and additional modules, which may include a detachable pole for additional stretching routines and an adjustable back stretcher, and/or others. In one or more versions, wellness systems of the present disclosure may provide a professional-grade, occupation-specific recovery system which may be designed for the unique ergonomic challenges of service and desk professionals, transcending the limitations of door-mounted and singular devices; and/or others.

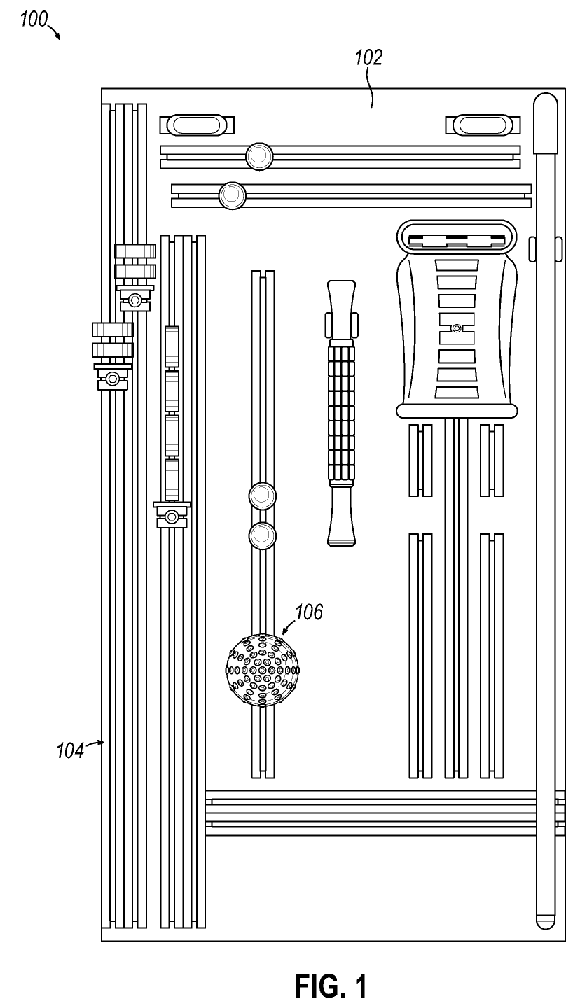

FIG. 1 illustrates a wellness system 100 of the present disclosure. In one or more versions, wellness system 100 may include a module interface panel 102 with a track system 104 consisting of multiple tracks secured to module interface panel 102 and one or more therapeutic modules 106 positionable on track system 104.

In one or more versions, module interface panel 102 of system 100 may be secured to a wall by with a French Cleat and/or an L Bracket using drywall anchor screws. In one or more versions, such securement systems may withhold between 50 and 200 pounds of weight on module interface system 102. In one or more versions, panel 102 of system 100 may be between about 10 and 24 inches in width and between about 30 and 48 inches in height.

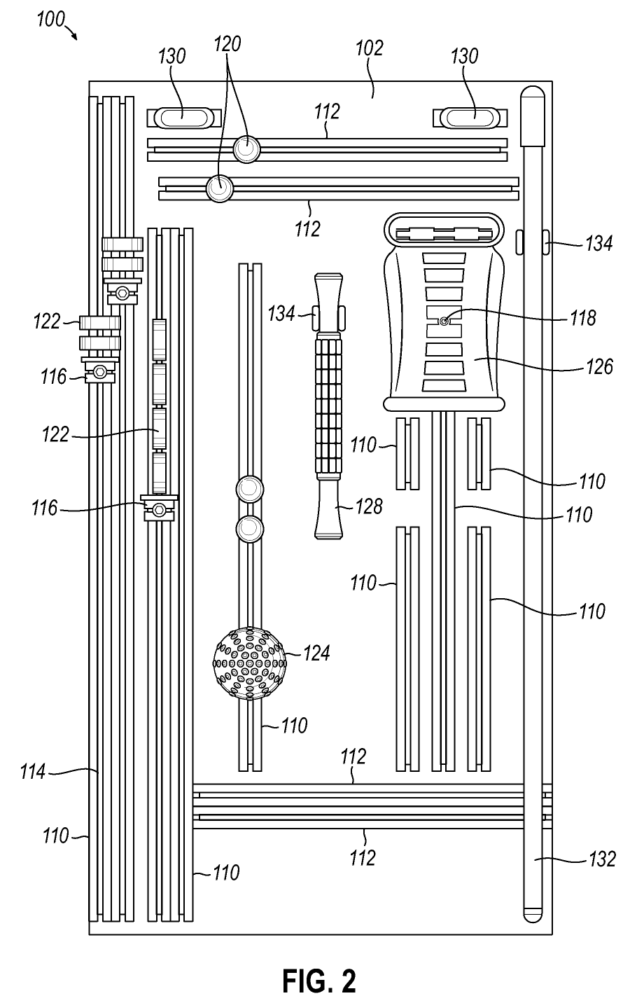

While FIG. 1 generally calls out and shows module interface panel 102, track system 106, and one or more therapeutic modules 106, FIG. 2 shows wellness system 100 generally calling out and showing the various elements of track system 104 and different example therapeutic modules 106. In one or more versions, track system 102 may consist of multiple vertical aluminum T-tracks 110 with various specifications and multiple horizontal aluminum T-tracks 112 constructed from 6063 aluminum alloy or other material. In one or more versions, one or more of T-Tracks 110, 112 may include parallel track configuration with 1 to 5-inch standard spacing, depending on module. In one or more versions, each T-Track 110, 112 includes an integrated T-slot 114 (only one of which is labeled in FIG. 2) allowing for seamless module attachment. In one or more versions, each T-Track 110, 112 may be any of four sizes depending on track configuration (3”, 12”,16”, 36”, 48”). In one or more versions, one or more of T-Tracks 110, 112 may include a T-track sled stop and/or sled knob 116. In one or more versions, each T-track 110, 112 of track system 102 may incorporate multiple engineered elements such as, but not limited to, single and dual-channel configurations with primary securing mechanisms; continuous engagement grooves running the length of each track; and/or end caps with integrated safety stops.

In one or more versions, wellness system 100 may further include quick-release locking mechanisms, stainless steel wingnuts (not shown); 1/4”-20 plastic thumb nuts mechanisms 118; universal mounting bolts compatible with all therapeutic modules (not shown), 1/4”-20 T-track bolts (1/2”, 1”, 1.5”, 2”, 3”, 4”) (not shown); and/or tool-free module exchange systems. Module interface 102 may also include one or more handles 130. In one or more versions, the one or more handles 130 may be utilized to help secure module interface system 102 to a wall and/or handles 130 may be utilized as a stabilizing mechanism for individuals to use while working with one or more of the therapeutic modules 106.

In one or more versions, the one or more therapeutic modules 106 may include one or more trigger point balls 120, one or more massage rollers 122, one or more spiked trigger point balls 124, and/or one or more adjustable back stretcher 126. In one or more versions the one or more trigger point balls 120, one or more massage rollers 122, one or more spiked trigger point balls 124, and one or more adjustable back stretcher 126, if present, may be secured to T-Tracks 110, 112. In one or more versions, the one or more therapeutic modules 106 may also include one or more removable massage sticks 128 and one or more removable poles 132. In one or more versions, one or more removable massage sticks 128 and one or more removable poles 132 may be attachable to module interface system 102 through the use or one or more adjustable tool clamps 134.

In one or more versions, the one or more trigger point balls 120 may be utilized to apply compressive pressure to targeted areas of muscular tension or myofascial trigger points, wherein a user positions one or more trigger point balls 120 along track system 104 to align with a specific tender or tight muscle. The user would then apply body weight pressure by leaning into the one or more trigger point balls 120 to facilitate release of localized tension.

In one or more versions, the one or more massage rollers 122 may be utilized to provide manual rolling myofascial pressure relief wherein the user applies controlled back-and-forth rolling motion along targeted muscle tissue to facilitate release of muscular tension and improve circulation in the targeted area.

In one or more versions, the one or more spiked trigger point balls 124 may be utilized to apply compressive pressure to targeted areas of muscular tension or myofascial trigger points, wherein the user positions one or more spiked trigger point balls 124 along track system 104 to align with a specific tender or tight muscle and applies body weight pressure by leaning into the one or more spiked trigger point balls 124 to facilitate the release of localized tension.

In one or more versions, the one or more adjustable back stretcher 126 may be utilized to provide assisted spinal extension and lower back decompression, wherein the user adjusts adjustable back stretcher 126 to the desired height along track system 104, stands facing away from module interface system 102, leans rearward into the curved surface of adjustable back stretcher 126, and raises their arms overhead to facilitate lumbar extension and relief of lower back muscular tension.

In one or more versions, the one or more removable massage sticks 128 may be utilized to apply rolling myofascial pressure to targeted muscle groups including the posterior cervical region, hips, glutes, and lower extremity musculature, wherein the user removes one or more removable massage sticks 128 from track system 104, grasps the handle grips at each end, and manually rolls the device along the affected tissue in a back-and-forth motion to facilitate myofascial release and relief of localized muscular tension.

In one or more versions, the one or more removable poles 132 may be utilized to facilitate assisted upper and lower body stretching. In one or more versions, the one or more removable poles 132 may be fabricated from aluminum, plastic, wood, or equivalent rigid material. To use the one or more removable poles 132, a user detaches removable pole 132 and grasps it at desired positions along its length to perform assisted stretching routines targeting the upper body including the shoulders, chest, and upper back, and lower body muscle groups including the hips, hamstrings, and glutes, to improve range of motion and facilitate relief of muscular tension.

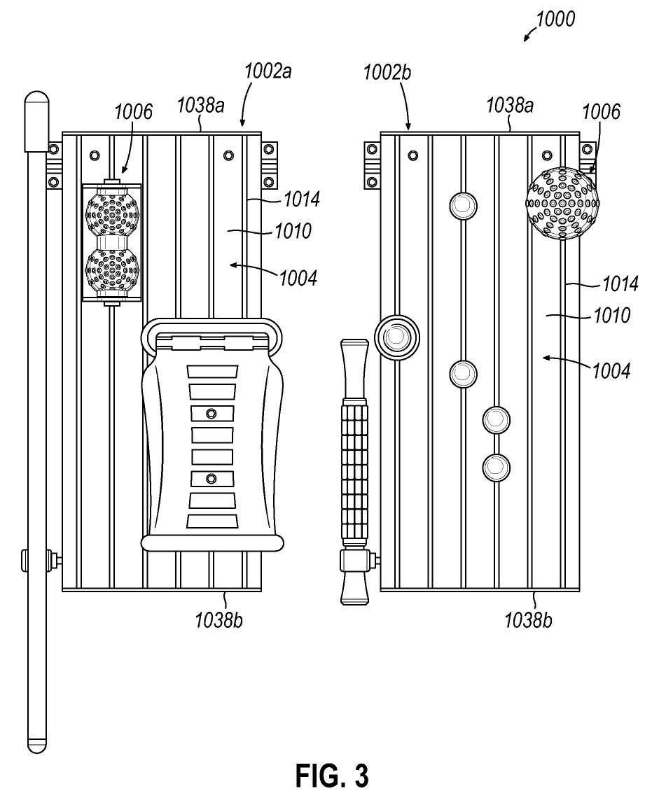

FIG. 3 illustrates a wellness system 1000 of the present disclosure. In one or more versions, wellness system 1000 may include a first module interface panel 1002a and a second module interface panel 1002b. Each module interface panel 1002a, 1002b includes a track system 1004 consisting of multiple tracks secured to module interface panels 1002a, 1002b and one or more therapeutic modules 1006 positionable on track system 1004. In one or more versions, each module interface panel 1002a, 1002b may be about 10 inches wide, about 30 inches tall, and about 1 inch deep. In one or more versions, each module interface panel 1002a, 1002b may be made from aluminum, plastic, wood, or equivalent rigid material.

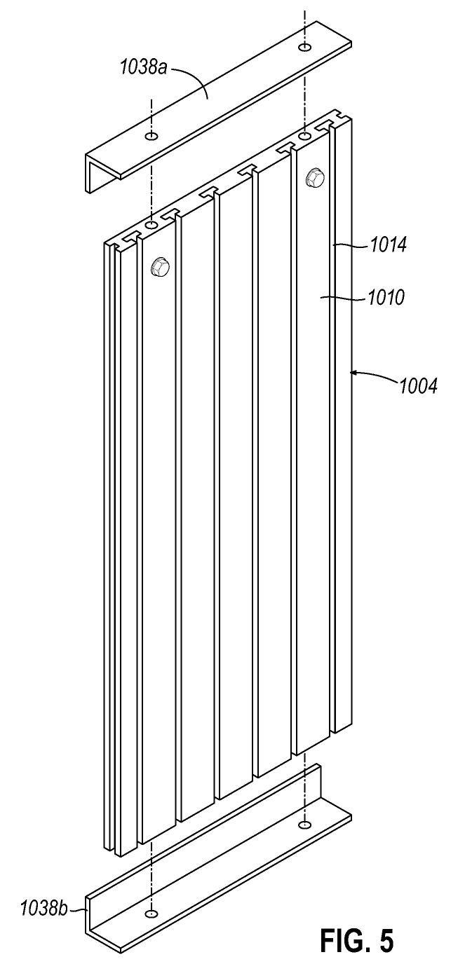

In one or more versions, module interface panels 1002a, 1002b of system 1000 may be secured to a wall by first securing a top mounting bracket 1036 to a wall surface. In one or more versions, top mounting bracket 1036 may be a French Cleat. Then, panels 1002a, 1002b will each include a top L-shaped mounting bracket 1038a and a bottom L-shaped mounting bracket 1038b, such as shown in FIG. 5. Top L-shaped mounting bracket 1038a will be secured to top mounting bracket 1036 and bottom L-shaped mounting bracket 1038b may be secured directly into the wall.

In one or more versions, top L-shaped mounting bracket 1038a and bottom L-shaped mounting bracket 1038b may create a standoff distance of approximately 0.5 to 2 inches between module interface panels 1002a, 1002b and the mounting surface. In one version, the standoff distance may be 1 inch. In one or more versions, having this standoff distance may provide improved ergonomic positioning and user stance during therapeutic use. In one or more versions, panels 1002a, 1002b of system 1000 may each be about 10 inches in width and about 30 inches in height.

In one or more versions, track system 1002 may consist of multiple vertical aluminum T-tracks 1010 constructed from 6063 aluminum alloy or other material. In one or more versions, one or more of T-Tracks 1010 may include parallel track configuration with 1 to 5-inch standard spacing, depending on module. In one or more versions, each T-Track 1010 an integrated T-slot 1014 (only one of which is labeled in FIGS. 3 and 5) allowing for seamless module attachment. In one or more versions, each T-Track 1010 may be any of four sizes depending on track configuration (3”, 12”,16”, 36”, 48”). In one or more versions, one or more of T-Tracks 1010 may include a T-track sled stop and/or sled knob (not shown). In one or more versions, each T-track 110 may incorporate multiple engineered elements such as, but not limited to, single and dual-channel configurations with primary securing mechanisms; continuous engagement grooves running the length of each track; and/or end caps with integrated safety stops

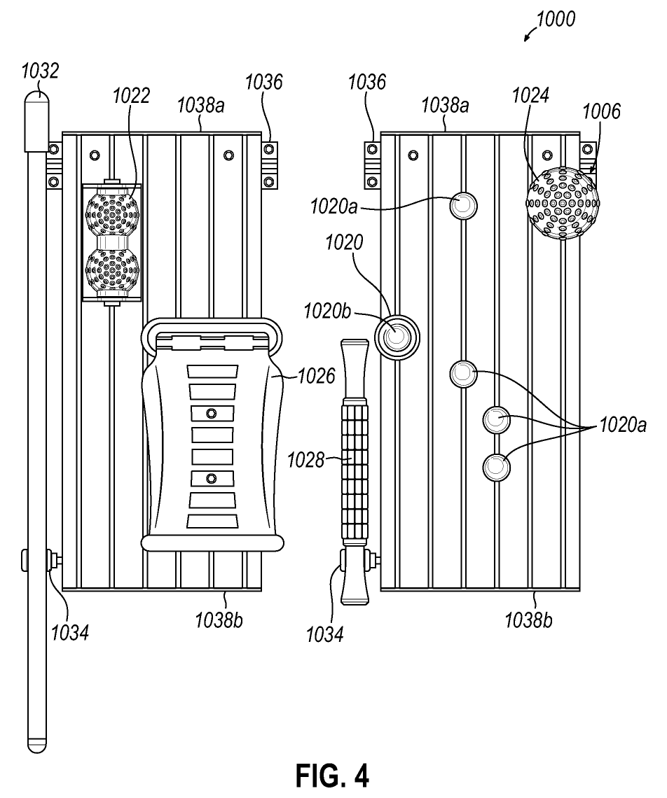

While FIG. 3 generally calls out and shows module interface panels 1002a and 1002b, track system 1006, and one or more therapeutic modules 1006, FIG. 4 shows wellness system 1000 generally calling out and showing different example therapeutic modules 1006.

In one or more versions, the one or more therapeutic modules 1006 may include one or more trigger point balls 1020a, one or more rolling trigger point balls 1020b, one or more peanut balls 1022, one or more spiked trigger point balls 1024, and/or one or more adjustable back stretcher 1026. In one or more versions the one or more trigger point balls 1020, one or more peanut balls 1022, one or more spiked trigger point balls 1024, and one or more adjustable back stretcher 1026, if present, may be secured to T-Tracks 1010. In one or more versions, the one or more therapeutic modules 1006 may also include one or more removable massage sticks 1028 and one or more removable poles 1032. In one or more versions, one or more removable massage sticks 1028 and one or more removable poles 1032 may be attachable to module interface systems 1002a, 1002b through the use or one or more adjustable tool clamps 1034.

In one or more versions, the one or more rolling trigger point balls 1020b may be mounted within a trigger point ball assembly 1046. In one or more versions, trigger point ball assembly 1046 may include a single smooth spherical element approximately 1.5 to 3 inches in diameter. In one or more versions, the single smooth spherical element may have a diameter of 2 inches. In one or more versions, trigger point ball assembly 1046 may be constructed of hard plastic or other suitable rigid material. In one or more versions, the spherical element of trigger point ball assembly 1046 may be housed within a hard plastic shell or carriage configured to allow omnidirectional rotation in all directions while retaining rolling trigger point balls 1020b securely within trigger point ball assembly 1046. In one or more versions, trigger point ball assembly 1046 may slide along the vertical length of a T-slot 1014 of one or more T-Tracks 1010 for positional adjustment.

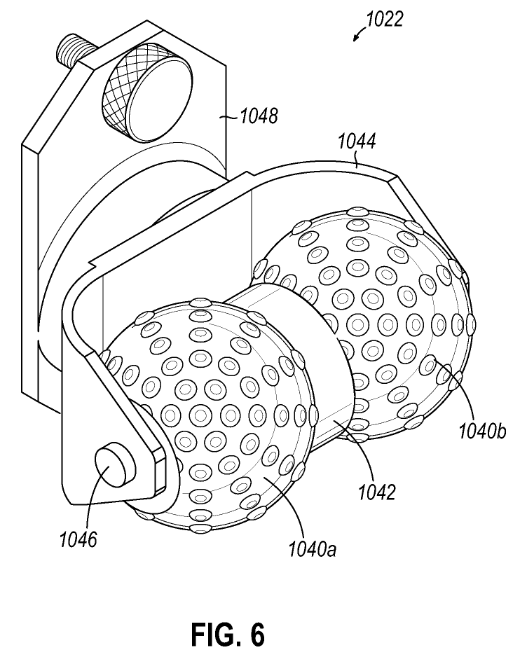

FIG. 6 shows peanut ball 1022 in more detail. In one or more versions, peanut ball 1022 may include first and second spherical massage elements 1040a and 1040b. As shown in FIG. 6, first and second spherical massage elements 1040a and 1040b may be connected to one another with a connection portion 1042. In one or more versions, each of first and second spherical massage elements 1040a and 1040b may be between 1.5 and 3 inches in diameter, may be constructed of hard rubber, and may contain surface nubs or protrusions for targeted trigger point therapy. In one or more versions, first and second spherical massage elements 1040a and 1040b may be suspended between a carriage 1044 with a metal tube or rod 1046 passing through each of first and second spherical massage elements 1040a and 1040b, with rod 1046 secured within carriage 1044. Rod 1046 passing through each of first and second spherical massage elements 1040a and 1040b may allow for each of first and second spherical massage elements 1040a and 1040b to rotate and spin freely within carriage 1044. In one or more versions carriage 1044 may be rotatably secured to a mount 1048, with mount 1048 slidably positioned within a T-slot 1014 of one or more T-Tracks 1010. With carriage 1044 being rotatably secured in this manner, carriage 1044 may rotate within a T-slot 1014 of one or more T-Tracks 1010.

In one or more versions, wellness systems of the present disclosure, such as wellness system 100 or 1000, may further include customization features. These features may include modular spacing adjustment or T-Tracks 110 or 1010, interchangeable therapeutic modules 106 or 1006, compatible third-party component adaptation system, or other customization features.

In one or more versions, module interface panels 102 or 1002a and 1002b may include a core material composition. The core material composition may include non-porous solid surface construction; impact-resistant formulation; seamless, non-porous surface finish; chemical and stain resistant; and/or scratch-resistant surface treatment.

In one or more versions, wellness systems of the present disclosure, such as wellness system 100 or 1000, may include hygiene features. Hygiene features may include a non-absorbent material structure; one or more seamless panel-to-panel joints; a coved corner system for easy cleaning; smooth radius edges; and/or a grout-free installation system.

Mounting a wellness system of the present disclosure, such as wellness system 100 or 1000, may include using a standard stud spacing compatibility; a minimum wall strength; one or more load distribution mounting plates; an installation template system; and/or a professional installation guide.

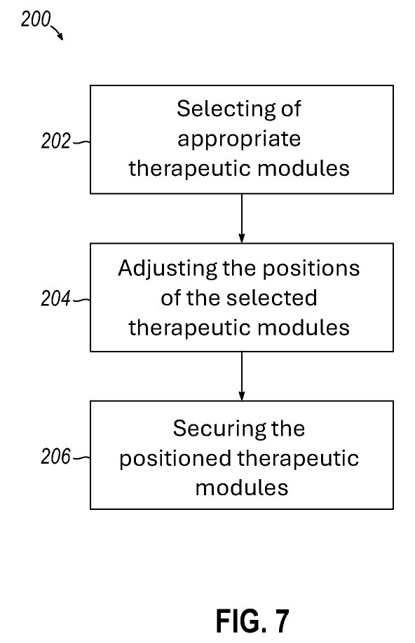

FIG. 7 illustrates an exemplary method 200 for customizing a wellness system. Method 200 may include a step 202 of selecting appropriate therapeutic modules 106 or 1006; a step 204 of adjusting positions of therapeutic modules 106 or 1006 within track system 106 or 1006; and a step of securing therapeutic modules 106 or 1006 in optimal positions within track system 106 or 1006.

### ILLUSTRATIVE COMBINATIONS

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A wall-mounted wellness system comprising: one or more module interface panels, wherein each module interface panel of the one or more module interface panels is securable to a wall; a track system secured to each of the one or more module interface panels, wherein the track system includes a plurality of T-tracks and each T-Track of the plurality of T-Tracks includes a T-Slot; and a plurality of interchangeable therapeutic modules positionable along the T-slots of the plurality of T-tracks; wherein each interchangeable therapeutic module of the plurality of interchangeable therapeutic modules is configured to be slidably adjustable along a length of at least one T-Track of the plurality of T-Tracks such that each interchangeable therapeutic module of the plurality of interchangeable therapeutic modules provides continuous positional adjustment.

### Example 2

The wall-mounted wellness system of Example 1, wherein each T-Track of the plurality of T-Tracks is made from 6063 aluminum alloy and wherein each T-Track of the plurality of T-Tracks further includes end caps with integrated safety stops.

### Example 3

The wall-mounted safety system of Example 1, wherein the track system includes a plurality of vertically-aligned T-Tracks and a plurality of horizontally-aligned T-Tracks.

### Example 4

The wall-mounted wellness system of Example 1, wherein each module interface panel of the one or more module interface panels further includes a French cleat securable to a wall and a top L-shaped bracket securable to each module interface panel of the one or more module interface panels, wherein the top L-shaped bracket is securable to the French cleat to secure each module interface panel of the one or more module interface panels to a wall.

### Example 5

The wall-mounted wellness system of Example 4, wherein each module interface panel of the one or more module interface panels further includes a bottom L-shaped bracket securable to each module interface panel and wherein the bottom L-shaped bracket is securable to the wall.

### Example 6

The wall-mounted wellness system of Example 1 including a first module interface panel and a second module interface panel.

### Example 7

The wall-mounted wellness system of Example 1, wherein the plurality of interchangeable therapeutic modules comprise at least one of: one or more trigger point balls, one or more rolling trigger point balls, one or more massage rollers, one or more spiked trigger point balls, one or more peanut balls, and one or more adjustable back stretchers.

### Example 8

The wall-mounted wellness system of Example 7, each peanut ball of the one or more peanut balls includes first and second spherical massage elements, a connection portion positioned between the first and second spherical massage elements, a carriage member holding the first and second spherical massage elements, a rod passing through the first and second spherical massage elements and secured to the carriage, and a mount with the carriage rotatably secured thereto.

### Example 9

The wall-mounted wellness system of Example 7, wherein each rolling trigger point ball of the one or more rolling trigger point balls is mounted within a trigger point ball assembly, wherein each trigger point ball assembly includes a spherical element retained in a carriage to allow for omnidirectional rotation of the rolling trigger point ball mounted therein.

### Example 10

The wall-mounted wellness system of Example 1, further comprising one or more removable massage sticks and one or more removable poles, wherein each of the one or more removable sticks and one or more removable poles are mountable on the one or more module interface panels through an adjustable tool clamp.

### Example 11

The wall-mounted system of Example 1, wherein the one or more module interface panels each include one or more handles configured to aid in mounting of the one or more module interface panels and for providing a user with a stabilizing grip surface.

### Example 12

A method of configuring a wall-mounted wellness system, the method comprising: selecting one or more therapeutic modules from a plurality of interchangeable therapeutic modules; positioning the at least one selected therapeutic module along a T-slot of a T-Track of a track system secured to one or more module interface panels; and securing the at least one selected therapeutic module in an operational position.

### Example 13

The method of Example 12, wherein the step of positioning comprises: sliding the at least one selected therapeutic module along the T-Track to align with a targeted muscle region of a user.

### Example 14

The method of Example 12, wherein the step of securing comprises: actuating a quick-release locking mechanism to lock the at least one therapeutic module at a selected position along the T-Track.

### Example 15

The method of Example 12, further comprising securing the one or more module interface panels to a wall prior to the step of positioning the at least one selected therapeutic module.

### Example 16

The method of Example 15, wherein the step of securing the one or more module interface panels includes: securing one or more French cleats to a wall, securing an L-Shaped top bracket to each of the one or more module interfaces, and securing the L-Shaped top bracket to a French cleat of the one or more French cleats.

### Example 17

The method of Example 12, further comprising securably positioning one or more removable massage sticks and one or more removable poles to the one or more module interfaces.

### Example 18

A therapeutic module assembly for a wall-mounted wellness system, the assembly comprising: a carriage; first and second spherical massage elements connected by a connection portion to define a peanut-shaped arrangement; a rod extending through the first and second spherical massage elements and coupled to the carriage to allow the first and second spherical massage elements to rotate; and a mount coupled to the carriage and configured to slidably engage a T-slot of a T-track of a track system of the wall-mounted wellness system.

### Example 19

The therapeutic module assembly of Example 18, wherein the carriage is rotatably secured to the mount so that the carriage is rotatable about an axis while the mount remains engaged in the T-slot.

### Example 20

The therapeutic module assembly of Example 18, wherein each of the first and second spherical massage elements has a diameter between about 1.5 inches and about 3 inches and comprises hard rubber having surface nubs or protrusions.

### MISCELLANEOUS

It should be understood that any of the versions of the wall-mounted wellness systems described herein may include various other features in addition to or in lieu of those described above. By way of example only, any of the wall-mounted wellness systems described herein may also include one or more of the various features disclosed in any of the various references that are incorporated by reference herein. It should also be understood that the teachings herein may be readily applied to any of the wall-mounted wellness systems described in any of the other references cited herein, such that the teachings herein may be readily combined with the teachings of any of the references cited herein in numerous ways. Other types of wall-mounted wellness systems into which the teachings herein may be incorporated will be apparent to those of ordinary skill in the art.

It should also be understood that any ranges of values referred to herein should be read to include the upper and lower boundaries of such ranges. For instance, a range expressed as ranging “between approximately 1.0 inches and approximately 1.5 inches” should be read to include approximately 1.0 inches and approximately 1.5 inches, in addition to including the values between those upper and lower boundaries.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods and systems described herein may be accomplished by appropriate modifications by one of ordinary skill in the art without departing from the scope of the present invention. Several such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings

I claim:

1. A wall-mounted wellness system comprising:
one or more module interface panels, wherein each module interface panel of the one or more module interface panels is securable to a wall;
a track system secured to each of the one or more module interface panels, wherein the track system includes a plurality of T-tracks and each T-Track of the plurality of T-Tracks includes a T-Slot; and
a plurality of interchangeable therapeutic modules positionable along the T-slots of the plurality of T-tracks;
wherein each interchangeable therapeutic module of the plurality of interchangeable therapeutic modules is configured to be slidably adjustable along a length of at least one T-Track of the plurality of T-Tracks such that each interchangeable therapeutic module of the plurality of interchangeable therapeutic modules provides continuous positional adjustment.

2. The wall-mounted wellness system of claim 1, wherein each T-Track of the plurality of T-Tracks is made from 6063 aluminum alloy and wherein each T-Track of the plurality of T-Tracks further includes end caps with integrated safety stops.

3. The wall-mounted safety system of claim 1, wherein the track system includes a plurality of vertically-aligned T-Tracks and a plurality of horizontally-aligned T-Tracks.

4. The wall-mounted wellness system of claim 1, wherein each module interface panel of the one or more module interface panels further includes a French cleat securable to a wall and a top L-shaped bracket securable to each module interface panel of the one or more module interface panels, wherein the top L-shaped bracket is securable to the French cleat to secure each module interface panel of the one or more module interface panels to a wall.

5. The wall-mounted wellness system of claim 4, wherein each module interface panel of the one or more module interface panels further includes a bottom L-shaped bracket securable to each module interface panel and wherein the bottom L-shaped bracket is securable to the wall.

6. The wall-mounted wellness system of claim 1 including a first module interface panel and a second module interface panel.

7. The wall-mounted wellness system of claim 1, wherein the plurality of interchangeable therapeutic modules comprise at least one of: one or more trigger point balls, one or more rolling trigger point balls, one or more massage rollers, one or more spiked trigger point balls, one or more peanut balls, and one or more adjustable back stretchers.

8. The wall-mounted wellness system of claim 7, each peanut ball of the one or more peanut balls includes first and second spherical massage elements, a connection portion positioned between the first and second spherical massage elements, a carriage member holding the first and second spherical massage elements, a rod passing through the first and second spherical massage elements and secured to the carriage, and a mount with the carriage rotatably secured thereto.

9. The wall-mounted wellness system of claim 7, wherein each rolling trigger point ball of the one or more rolling trigger point balls is mounted within a trigger point ball assembly, wherein each trigger point ball assembly includes a spherical element retained in a carriage to allow for omnidirectional rotation of the rolling trigger point ball mounted therein.

10. The wall-mounted wellness system of claim 1, further comprising one or more removable massage sticks and one or more removable poles, wherein each of the one or more removable sticks and one or more removable poles are mountable on the one or more module interface panels through an adjustable tool clamp.

11. The wall-mounted system of claim 1, wherein the one or more module interface panels each include one or more handles configured to aid in mounting of the one or more module interface panels and for providing a user with a stabilizing grip surface.

12. A method of configuring a wall-mounted wellness system, the method comprising:
selecting one or more therapeutic modules from a plurality of interchangeable therapeutic modules;
positioning the at least one selected therapeutic module along a T-slot of a T-Track of a track system secured to one or more module interface panels; and
securing the at least one selected therapeutic module in an operational position.

13. The method of claim 12, wherein the step of positioning comprises:
sliding the at least one selected therapeutic module along the T-Track to align with a targeted muscle region of a user.

14. The method of claim 12, wherein the step of securing comprises:
actuating a quick-release locking mechanism to lock the at least one therapeutic module at a selected position along the T-Track.

15. The method of claim 12, further comprising securing the one or more module interface panels to a wall prior to the step of positioning the at least one selected therapeutic module.

16. The method of claim 15, wherein the step of securing the one or more module interface panels includes:
securing one or more French cleats to a wall,
securing an L-Shaped top bracket to each of the one or more module interfaces, and
securing the L-Shaped top bracket to a French cleat of the one or more French cleats.

17. The method of claim 12, further comprising securably positioning one or more removable massage sticks and one or more removable poles to the one or more module interfaces.

18. A therapeutic module assembly for a wall-mounted wellness system, the assembly comprising:
a carriage;
first and second spherical massage elements connected by a connection portion to define a peanut-shaped arrangement;
a rod extending through the first and second spherical massage elements and coupled to the carriage to allow the first and second spherical massage elements to rotate; and
a mount coupled to the carriage and configured to slidably engage a T-slot of a T-track of a track system of the wall-mounted wellness system.

19. The therapeutic module assembly of claim 18, wherein the carriage is rotatably secured to the mount so that the carriage is rotatable about an axis while the mount remains engaged in the T-slot.

20. The therapeutic module assembly of claim 18, wherein each of the first and second spherical massage elements has a diameter between about 1.5 inches and about 3 inches and comprises hard rubber having surface nubs or protrusions.
